(19) United States
(12) Patent Application Publication
(10) Pub. No.: US 2023/0057537 A1
(43) Pub. Date: Feb. 23, 2023

(54) FACILITATING STRIATED RANDOM RESTART DURING ALLOCATION OF RESOURCES USING A HEURISTIC APPROACH

(71) Applicant: AT&T Intellectual Property I, L.P., Atlanta, GA (US)

(72) Inventors: Rudolph Mappus, Plano, TX (US); Laxmikanth Vallamsetla, Plano, TX (US); Surekha Padala, Plano, TX (US)

(21) Appl. No.: 17/396,232

(22) Filed: Aug. 6, 2021

(51) Int. Cl. G06Q 10/06; G06K 9/62; G06N 5/00

(52) U.S. Cl. CPC G06Q 10/06312; G06Q 10/063116; G06K 9/6223; G06K 9/623; G06N 5/003

(57) ABSTRACT

Facilitating striated random restart during routing of resources using a heuristic approach is provided herein. Operations of a system can include, separating objects of a group of objects into a first grouping and a second grouping, assigning first objects of the first grouping and second objects of the second grouping to respective resource elements, resulting in a first classification. A search space is enabled and includes, at respective iterations of a group of iterations, selecting a defined priority level, removing third objects of the second grouping that do not satisfy the defined priority level from the first classification, and assigning the third objects to the respective resource elements, resulting in a second classification. The first objects and the second objects, other than the third objects, remain assigned according to the first classification. According to an implementation, the schedule search reduces a search space of the group of objects.

### TECHNICAL FIELD

This disclosure relates generally to the field of heuristics in computer science and, more specifically, to striated random restart for resource allocation.

### BACKGROUND

Operations research is a field of study that has a focus related to how to make optimal decisions in various contexts. When performing operations research, when attempting to make optimal decisions, theoretical results in computer science show that no general solution method exists that will provide an exact solution to those decisions in a reasonable amount of time unless P=NP. That is, the set of problems (e.g., decisions) solvable in polynomial time using a nondeterministic Turing machine are in the set of problems solvable in polynomial time with a deterministic Turing machine. Currently it is widely believed that P≠NP. Heuristic optimization methods generate feasible, approximately optimal solutions for a given objective and set of constraints. Accordingly, unique challenges exist as it relates to attempting to make optimal decisions using computer science.

### BRIEF DESCRIPTION OF THE DRAWINGS

Various non-limiting embodiments are further described with reference to the accompanying drawings in which:

FIG. 1 illustrates an example, non-limiting, computer-implemented method for facilitating striated random restart during resource allocation using a heuristic approach in accordance with one or more embodiments described herein;

FIG. 2 illustrates an example, non-limiting, system that facilitates striated random restart during routing of resources using a heuristic approach in accordance with one or more embodiments described herein;

FIGS. 3A, 3B, and 3C illustrate example, non-limiting schematic representations of objects being assigned to resources in accordance with one or more embodiments described herein;

FIG. 4 illustrates an example, non-limiting, computer-implemented method for facilitating striated random restart during routing of objects using a heuristic approach in accordance with one or more embodiments described herein;

FIG. 5 illustrates a flow diagram of an example, non-limiting, computer-implemented method that facilitates reducing a search space during allocation of resources in accordance with one or more embodiments described herein;

FIG. 6 illustrates an example, non-limiting, computer-implemented method that facilitates a striated random restart during routing of resources using a heuristic approach in accordance with one or more embodiments described herein;

FIG. 7 illustrates a graph of a first group of simulated cases and related performance comparisons in accordance with one or more embodiments described herein;

FIG. 8 illustrates a graph of a second group of simulated cases and related performance comparisons in accordance with one or more embodiments described herein;

FIG. 9 illustrates an example, non-limiting, block diagram of a handset operable to engage in a system architecture that facilitates wireless communications according to one or more embodiments described herein; and

FIG. 10 illustrates an example, non-limiting, block diagram of a computer operable to engage in a system architecture that facilitates wireless communications according to one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular networked environment or standard).

Described herein are systems, methods, articles of manufacture, and other embodiments or implementations that can facilitate striated random restart during allocation of resources using a heuristic approach. In one embodiment, described herein is a method that includes, based on defined constraints associated with objects of a group of objects, allocating, by a system including a processor, the objects to respective resource elements of a group of resource elements, resulting in a first allocation. Respective priority levels are assigned to the objects. The method also can include reassigning, by the system, first objects of the group of objects to the respective resource elements, resulting in a second allocation. The first objects can include respective priority levels that fail to satisfy a threshold priority level. Further, second objects of the group of objects remain assigned according to the first allocation. The second objects can include respective priority levels that satisfy the threshold priority level. Further, the method can include, based on a determination that a first rank of the first allocation is a higher rank than a second rank of the second allocation, facilitating, by the system, implementation of the first allocation. The second allocation can be discarded, or ignored. In an example, the defined constraints can include, for respective resource elements, a distance time and an idle time.

According to some implementations, reassigning the first object can include reducing a search space of the group of objects. Allocating the objects, reassigning the first objects, and facilitating the implementation are performed within a defined time period. In some implementations, reassigning the first objects can include permuting, by the system, the first objects randomly between the respective resource elements. In an example, reassigning the first objects includes using a striation function to divide the group of objects into a finite number of groupings. Further to this example, respective objects of the group of objects belong to a single grouping of the finite number of groupings.

In some implementations, the method can include, based on a second determination that the second rank of the second allocation is more than (e.g., better than) the first rank of the first allocation, facilitating, by the system, implementation of the second allocation. Facilitating the second allocation can include discarding the first allocation.

The method can include, according to some implementations, reassigning, by the system, third objects of the group of objects to the respective resource elements, resulting in a third allocation. The third objects include respective priority levels that fail to satisfy the threshold priority level. Fourth objects of the group of objects remain assigned according to the first allocation. The fourth objects include respective priority levels that satisfy the threshold priority level. Further to these implementations, the method can include, based on a second determination that a third rank of the third allocation is more than the first rank of the first allocation, facilitating, by the system, implementation of the third allocation. Facilitating the third allocation can include discarding the first allocation.

Another embodiment provided herein is a system that includes a processor and a memory that stores executable instructions that, when executed by the processor, facilitate performance of operations. The operations can include separating objects of a group of objects into a first grouping and a second grouping and assigning first objects of the first grouping and second objects of the second grouping to respective resource elements, resulting in a first classification. Further, the operations can include enabling a schedule search. Enabling the schedule search can include, at respective iterations of a group of iterations, selecting a defined priority level based on respective defined priority levels assigned to the objects of the group of objects. Further, enabling the schedule search can include removing third objects of the second grouping that do not satisfy the defined priority level from the first classification. Additionally, enabling the schedule search can include assigning the third objects to the respective resource elements, resulting in a second classification. The first objects and the second objects, other than the third objects, remain assigned according to the first classification. According to an implementation, the schedule search reduces a search space of the group of objects.

In an example, the first objects are classified as anchor objects that satisfy one of a defined priority level or a defined duration level. In another example, after assigning the first objects, the operations include randomly permutating the second objects among the respective resource elements.

According to some implementations, separating the objects into groupings can include using a striation function that separates the objects into a finite number of groupings. In an example, the striation function is an unsupervised clustering process. In another example, the striation function is a quintile operation. According to another example, the striation function is a quartile operation. In yet another example, the striation function is a decile operation.

Another embodiment provided herein is a non-transitory machine-readable medium, including executable instructions that, when executed by a processor, facilitate performance of operations. The operations can include determining a first assignment of objects, determining a second assignment of objects, determining a first ranking for the first assignment of objects and a second ranking for the second assignment of objects, and facilitating implementation of the second assignment of objects based on the second ranking being determined to be a higher ranking than the first ranking. Determining the first assignment can include segregating a group of objects into a first group of first objects and a second group of second objects using a striation process. Determining the first assignment can also include assigning the first objects to resource elements, wherein the first objects satisfy a defined priority level. Further, determining the first assignment can include, after assigning the first objects, assigning the second objects to the resource elements, wherein the second objects fail to satisfy the defined priority level. Determining the second assignment can include segregating the second objects into third objects and fourth objects using the striation process and reassigning the third objects to the resource elements, wherein the fourth objects and the first objects are not reassigned.

According to an implementation, determining the first assignment of objects and determining the second assignment of objects includes reducing a search space associated with the group of objects. In some implementations, determining the first assignment of objects, determining the second assignment of objects, determining the ranking, and facilitating implementation of the second assignment are executed by the processor within a defined time period.

Operations research is a field of study that is concerned with how to make optimal decisions in various contexts. For example, consider a machine shop (e.g., managing entity) with jobs (e.g., resources or resource elements) to complete. The jobs are processed through a series of machines that work with one item at a time and that take different amounts of time to complete. How a set of such jobs should be scheduled so that the highest number of jobs can be completed in a defined time period is an optimization problem. Being able to complete more jobs enables the shop to perform more work during the defined time period.

As mentioned, for many of these types of problems, theoretical results in computer science show that no general solution method exists that will provide an exact solution to those problems in a reasonable amount of time unless P=NP. That is, the set of problems solvable in polynomial time using a nondeterministic Turing machine are in the set of problems solvable in polynomial time with a deterministic Turing machine. Currently, it is widely believed that P≠NP.

As also mentioned, heuristic optimization methods generate feasible, approximately optimal solutions for a given objective and set of constraints. In problems where constraints are difficult to articulate, where exact constrained optimization methods are not permissible, or combinatorial methods require a solve time that is greater than requirements, heuristic methods can produce results. Heuristic methods can include, for example, random search methods (e.g., randomized hill climbing) genetic processes, and simulated annealing. For a class of problems, there are cases that are more difficult to satisfy than others. There are often some instances that can be interchanged with other instances without sacrificing solution quality.

Another problem for managing entities that complete field work, that manage fleets of vehicles, and/or that allocate other type of objects, is the Capacitated Vehicle Routing Problem (CVRP). In the case of field tasks, for example, the CVRP is a determination of how to best assign a set of field tasks to a set of vehicles in order to complete the set of field tasks. Jobs have nonnegative loads and vehicles have nonnegative capacities. Thus, the objective is to minimize the tour lengths (sum of the distances between scheduled jobs) while assigning all jobs to vehicles. This problem has been shown to be the same complexity as the travelling salesman problem, which is a problem in the NP class of problems.

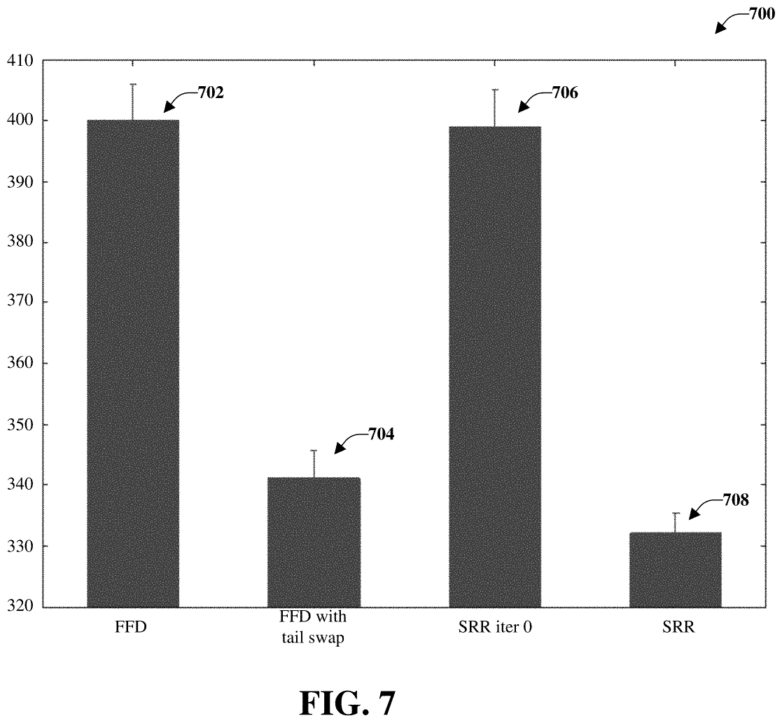

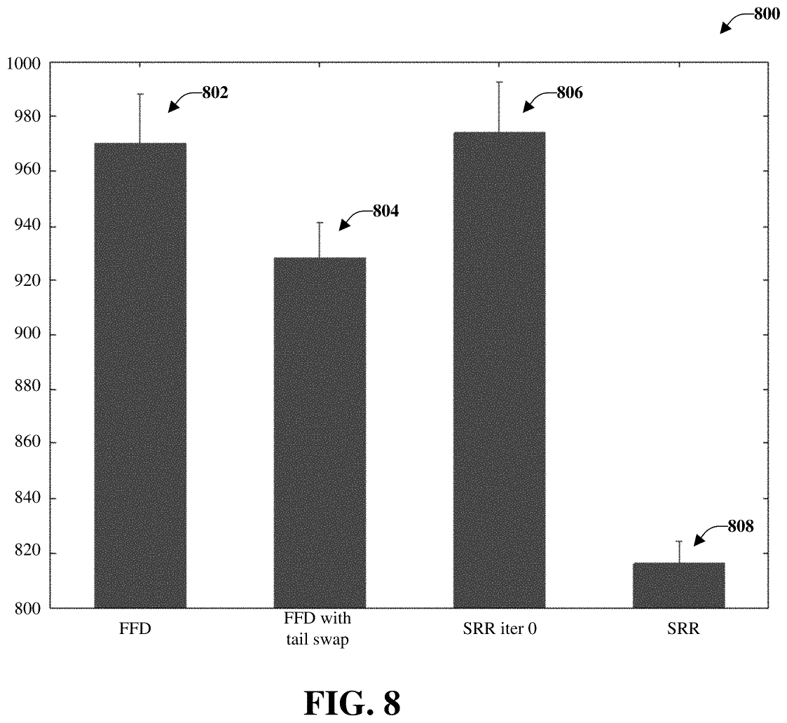

The disclosed embodiments are a novel heuristic method for solving CVRPs that ranks jobs and uses job ranks to generate new assignments to discover improved solutions. As will be discussed in further detail below, results obtained with the disclosed embodiments are compared on canonical CVRPs to existing heuristic processes (see, for example, FIGS. 7 and 8 below).

For the avoidance of doubt, any embodiments described herein in the context of optimal are not so limited and should be considered also to cover any techniques that implement underlying aspects or parts of the described aspects to improve or increase allocation of resources, reducing and/or minimizing a search space, and so on, even if resulting in a sub-optimal variant obtained by relaxing aspects or parts of a given implementation or embodiment.

By way of example and not limitation, assigning jobs to technicians can be solved as a combinatoric optimization problem. For example, the combinatoric optimization problem can be solved as a search through all possible assignments of jobs that satisfy constraints expressed as inequalities of variables. The goal of the search is to find the best feasible assignment based on the objective (e.g., minimize drive time and technician idle time).

Many computational problems can be posed as search problems. For example, the search problems can relate to how to efficiently (or optimally) evaluate a set of candidate solutions for the best solution when the search space is larger than what can be exhaustively searched in a finite (reasonable for the solution) amount of time (e.g., a defined time period). In optimization problems, when searching for best solutions, some methods have been developed that find best solutions when the objective function (the function that maps candidate solutions to real valued scores) is convex. For a large class of problems, objective functions are non-convex, and the search space of candidate solutions does not permit an exhaustive search. In these cases, heuristic search methods are a broad class of methods used to find solutions. While solutions recovered using heuristic search are better than random guesses, such solutions are not guaranteed to be globally optimal in contrast to other closed form solution optimization methods.

In the context of the example, non-limiting, vehicle routing problem for a technician workforce, the disclosed embodiments facilitate finding an assignment of jobs to technicians that minimize at least two objectives. In an example, the objectives can be driving miles and technician idle time, subject to constraints of both jobs and technicians. Technicians are trained to perform certain types of work (e.g., fiber optic vs. copper cables), and jobs have skill requirements to complete. Technicians have specific shift times they work, and jobs have specific commitment time windows. By minimizing both driving miles and idle time within these constraints, technician productive time can be maximized, solving more problems for customers, and ultimately improving overall network health. There are two primary distinctions to make. The first distinction are feasible solutions and invalid schedules. Feasible solutions are those solutions that represent valid work schedules that satisfy all the constraints around scheduling. These are distinct from invalid schedules where, for a given schedule, not every constraint is satisfied. The other distinction is deciding among the found feasible solutions which is the best, where a function that maps each schedule to a score is utilized. The score represents the quality of the solution.

As discussed herein, the set of job locations that are to be scheduled for a day in a geographic area is J and individual job locations j∈J and each job j is a geographic point (x, y). Similarly, the set of technicians that work in a geographic area T and individual technicians t∈T. Technicians start the day at a location (x, y) and return to that location when all assigned jobs are completed. The distance between two locations l₁, l₂ is defined as m(l₁, l₂). The technician start points are defined as tₚ. A technician job tour is the sum of the distances travelled from the starting point to the first job, between each successive job in their assignment, and from the last job back to the starting point:

$${τ}_{t} = m ( {t}_{p} , {j}_{0} ) + {\sum }_{i = 1}^{t} m ( {j}_{i - 1} , {j}_{i} ) . \qquad Equation 1$$

The idle time (the time between jobs not including drive time) where dᵢ is the end time of job in minutes of the day i and gᵢ is the start time of job in minutes of the day:

$${σ}_{t} = {\sum }_{i = 1}^{j} {d}_{i - 1} - {g}_{i} . \qquad Equation 2$$

Finally, a schedule's objective ω is the sum of all the technicians scheduled:

$$ω = {\sum }_{i = 1}^{t} {τ}_{1} + {σ}_{i} . \qquad Equation 3$$

Some heuristic optimization methods consist of two stages: feasible solution finding and a heuristic search to find improved assignments. In greedy solutions, a feasible assignment is generated by making assignment “moves” where a single job is assigned to a technician that satisfies all the job constraints. A feasible solution is where all jobs are assigned to the available technicians. Greedy methods for job assignment begin with the list of jobs and sequentially assign jobs until all jobs are scheduled. For example, job striations can be used to greedily schedule jobs. Once a feasible solution is found, traditional greedy solutions use sequences of jobs assigned and attempt to swap chains of jobs between technicians to search for additional improvements.

A difference with striated assignment, as provided herein, is that once feasible solutions are found, the disclosed embodiments can randomly search in striations to find improvements. A method that can be used for this strategy is first fit decreasing (FFD) with tail swaps. In first fit decreasing, jobs are ordered by criteria and then assigned to the first available vehicle, until all jobs are assigned (a feasible solution). The tail swap stage randomly selects pairs of vehicles and randomly selects a tail length and swaps the job sequences between the vehicle pairs. The intuition is that by maintaining the relative job sequences of the tails and swapping them, feasible solutions are found that may lower the tour lengths of the two vehicles.

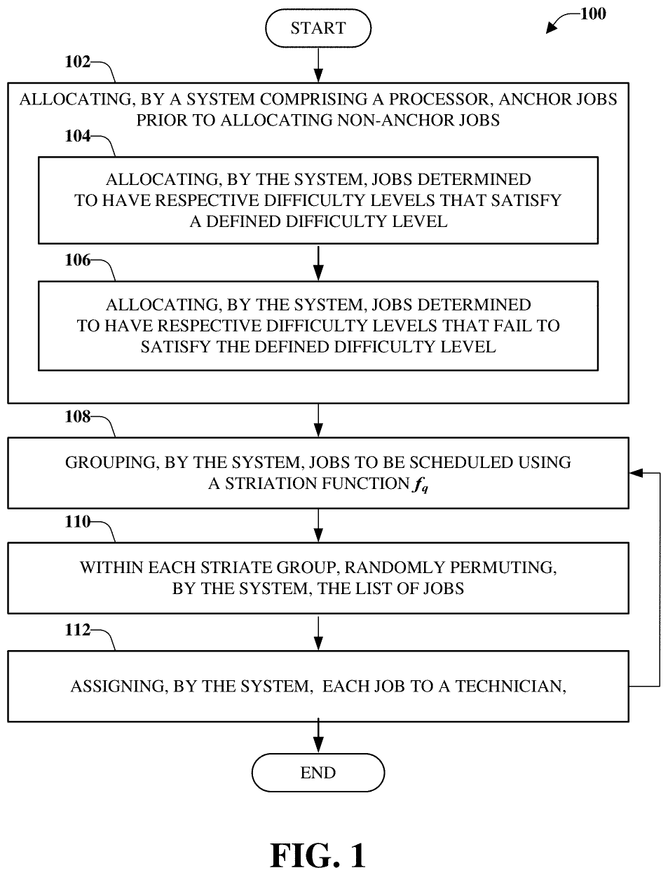

FIG. 1 illustrates an example, non-limiting, computer-implemented method 100 for facilitating striated random restart during resource allocation using a heuristic approach in accordance with one or more embodiments described herein. The computer-implemented method 100 can be implemented by a system including a processor, network equipment including a processor, or another computer-implemented device including a processor.

For example purposes only, FIG. 1 will be discussed with respect to allocating jobs. However, other resources can be allocated in a similar manner and the disclosed embodiments are not limited to jobs. According to example, non-limiting, embodiments, an observation about scheduling jobs in a managing entity's field operations is used. This observation is that there are a relatively small number of “anchor” jobs that have high priority and/or duration. Thus, anchor jobs are allocated, at 102, prior to allocation of non-anchor jobs. In an example, allocating the anchor jobs can include scheduling the anchor jobs to respective technicians (or respective vehicles). Scheduling anchor jobs first affords more flexibility for fitting other jobs to the schedule and improves schedule quality (as in first fit decreasing). However, moving anchor jobs between technicians due to their duration or priority does not affect the quality of the search space. For example, jobs that take most of the day to complete can be scheduled to a technician and moving that job to another technician does not affect the search space of quality feasible solutions.

In a similar manner as first fit decreasing, to schedule the anchor jobs first, at 104, jobs with the greatest amount of difficulty can be scheduled. For example, jobs determined to have respective difficulty levels that satisfy a defined difficulty level are scheduled, at 104. After the jobs having the greatest amount of difficulty are scheduled, at 106, the remaining jobs (e.g., the easier jobs) are scheduled. Although discussed with respect to difficulty, the anchor jobs can be determined based on respective priority levels or based another defined criterion, according to some implementations.

Using the groupings (striations) of jobs, the method maintains search diversity (the different combinations of solutions). By scheduling anchor jobs first, the method focuses on scheduling the remaining jobs by ordering jobs through striation. Those jobs in the lowest strata are the ones that receive more schedule swaps to find higher quality schedules. See, for example, the first procedure below.

After the initial allocation (at 102) and/or the scheduling (at 104 and 106), the non-anchor jobs are removed from the allocation and reallocated. Thus, at 108, the method first groups jobs to be scheduled using a striation function ƒ_{q}. The method supports any function that splits the jobs into a finite number of groups, where every job belongs to one group and no job occupies more than one group. Quintile, quartile, and decile operations for estimated job durations and/or locations all represent valid striation functions. Unsupervised clustering methods (e.g., k-means clustering) are also valid striation functions where some prioritization orders clusters. Cardinality based prioritization uses cluster set sizes to prioritize clusters. Ascending prioritization places higher weight on clusters with higher cardinality while descending prioritization places higher weight on smaller cluster sizes. In the context of job scheduling, lower cardinality clusters may represent “anchor” job sets that contain jobs harder to fit in later assignment iterations. Distance based prioritization uses statistics of the instance distances to the cluster centers to prioritize clusters. In the context of job scheduling, clusters with lower distances from instances to centers represent more compact groups of jobs indicating perhaps a strong similarity of jobs than clusters with higher mean distance to the cluster center.

Within each striate group, at 110, the method randomly permutes the list of jobs and, at 112, assigns each job to a technician. After a feasible solution is found, the method uses the strata to enable schedule search. Accordingly, the computer-implemented method 100 returns to 108 and groups jobs using a striation function. The striation function at each repeat or reevaluation of allocation can be a same striation function or a different striation function.

At each iteration, a random stratum is selected and the jobs within that stratum and below are removed from the schedule. The method then schedules those jobs back into the existing schedule. If the resulting feasible schedule improves over the current schedule, it is retained, and the search continues until convergence or iteration limits are met. See, for example, the second procedure below.

The first procedure utilized with the disclosed embodiments is a striated random restart at iteration 0. The first procedure is defined as:

Data: List of jobs j ∈ J order by score sⱼ ← S_{(J)} using score function s(j);
List of technicians T:
Result: Feasible job assignment schedule ω
Striate jobs using Q ← f_{q}(J);
foreach q ∈ Q do

| \| | Random shuffle jobs in q; | |
|---|---|---|
| \| | Foreach j ∈ q do | |
| \| | \| | Schedule j to t ∈ T; |
| \| | \| | if scheduled jobs demands less than capacity then |
| \| | \| | \| Update candidate schedule c; |
| \| | \| | end |

| | |
|---|---|
| \| | end |

end
if feasible(c) then

| | |
|---|---|
| \| | w ← c |

end

First procedure.

Further, the second procedure utilized with the disclosed embodiments is a striated random restart procedure. The second procedure is defined as:

Data: Feasible job assignment schedule ω;
Convergence threshold x;
Max iterations count i;
Result: Feasible job assignment schedule ω′
while |τ(ωⁱ) − τ(ω)| > x or iterations reached do

| \| | Random select strata level; | |
|---|---|---|
| \| | Remove schedule jobs at selected strata and lower J′; | |
| \| | Striate jobs Q′ ← f_{q}(Jⁱ); | |
| \| | foreach j to t ∈ q do | |
| \| | \| | Schedule j to t ∈ T; |
| \| | \| | Update c; |

| | |
|---|---|
| \| | end |

end

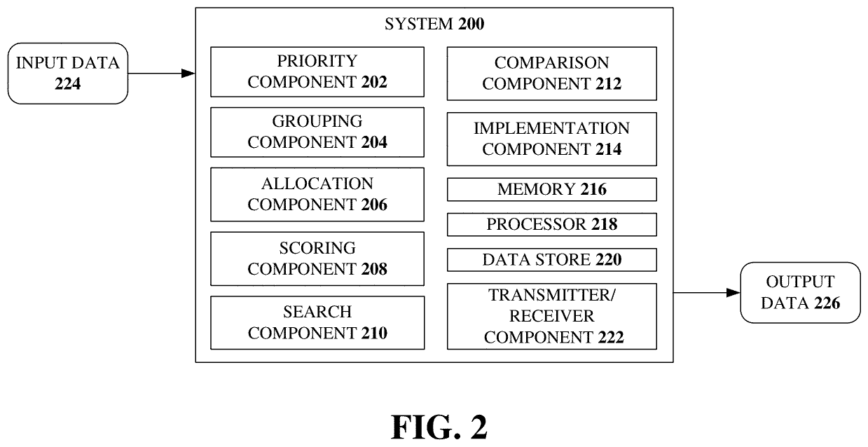

FIG. 2 illustrates an example, non-limiting, system 200 that facilitates striated random restart during routing of resources using a heuristic approach in accordance with one or more embodiments described herein.

Aspects of systems (e.g., the system 200 and the like), apparatuses, and/or processes (e.g., computer-implemented methods) explained in this disclosure can include machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described. In various embodiments, the system 200 can be any type of component, machine, device, facility, apparatus, and/or instrument that can include a processor and/or can be capable of effective and/or operative communication with a wired and/or wireless network.

The system 200 can include a priority component 202, a grouping component 204, an allocation component 206, a scoring component 208, a search component 210, a comparison component 212, an implementation component 214, at least one memory 216, at least one processor 218, at least one data store 220, and a transmitter/receiver component 222. In various embodiments, one or more of the priority component 202, the grouping component 204, the allocation component 206, the scoring component 208, the search component 210, the comparison component 212, the implementation component 214, the at least one memory 216, the at least one processor 218, the at least one data store 220, and the transmitter/receiver component 222 can be electrically and/or communicatively coupled to one another to perform one or more of the functions of the system 200. In some embodiments, one or more of the priority component 202, the grouping component 204, the allocation component 206, the scoring component 208, the search component 210, the comparison component 212, the implementation component 214, the transmitter/receiver component 222 and/or other components can include software instructions stored on the at least one memory 216 and/or the at least one data store 220 and executed by the at least one processor 218. The system 200 may also interact with other hardware and/or software components not depicted in FIG. 2.

The priority component 202 can receive input data 224 (e.g., via the transmitter/receiver component 222). The input data 224 can include a listing of objects, associated priorities assigned to the objects, and other data associated with the objects. In an example where the objects are service tasks, the other data associated with the objects can include a prediction of an amount of time needed to perform a service associated with the object (e.g., installation time, repair time, and so on), a skillset needed by a technician to perform the service, respective information associated with technicians (e.g., skill level, work hours, and so on). According to some implementations, the priority component 202 can determine a priority associated with each object based on the input data 224, historical data, an inference, and so on.

Based on at least a portion of the input data 224, the grouping component 204 can separate objects (e.g., jobs) of a group of objects into a first grouping and a second grouping. The first grouping can be objects that are determined to be anchor objects, which can be determined based at least in part on the respective priorities of the objects.

The allocation component 206 can assign first objects of the first grouping (e.g., anchor objects) to respective resource elements (e.g., see the first procedure above). Thereafter, the allocation component 206 can assign second objects of the second grouping to respective resource elements, until all objects are scheduled to resource elements. The first objects and the second objects can be assigned to the same resource elements or to different resource elements. According to the determined priority levels, the allocation component 206 can assign first objects of a first grouping and second objects of a second grouping to respective resource elements (resulting in a first classification, or an initial assignment).

The scoring component 208 can determine a score for the first classification. The score can indicate the quality level of the assignment. The scoring can be based on whether all the jobs, as assigned to a vehicle, are completed within a defined period of time (e.g., during the assigned shift of the technicians (e.g., over a period of 8 hours)), while allowing the technician adequate time to return the vehicle to the garage. In another example, the score can be based on whether the jobs, as assigned to a vehicle, are completed in less than the defined period of time, and so on. The respective scores assigned to each technician/vehicle can be averaged to determine a final score, according to some implementations.

The search component 210 can enable a schedule search (e.g., see the second procedure above). For example, by enabling the scheduled search, the search component 210 can reduce a search space associated with allocation of objects as discussed herein. Since there can be numerous combinations of how the objects can be assigned to the resource elements, it might be impractical to model all such assignments in a defined amount of time. Therefore, the search component 210 can intelligently select only a subset of the objects to reassign during each iteration of the model.

To perform the schedule search, the priority component 202 can determine a priority level for reassignment of objects that fail to satisfy the priority level (e.g., objects that satisfy the priority level are not changed from the initial assignment). Thus, objects that have a priority level at or below the level selected by the priority component 202 can be reassigned, by the allocation component 206, to the various resource elements, resulting in a second assignment. The reallocation is performed by the allocation component 206 in view of the constraints (e.g., skill level needed for each job, estimated time for completion of each job, and so on). The scoring component 208 can assign a second score to the second assignment.

Thereafter, the search component 210 can facilitate another schedule search based on another priority level (e.g., a third priority level) selected by the priority component 202, and so on for any number of subsequent searches/reclassifications of objects (e.g., loops) during a defined time interval. The scoring component 208 can individually score each subsequent assignment.

Further, the comparison component 212 can compare the one or more scores assigned by the scoring component 208. For example, the comparison component 212 can perform the comparison and output, as output data 226, a selected assignment of objects to respective resource elements. In some implementations, the comparison component 212 can perform the comparison at each iteration, which can further reduce a search space or processing time. However, in some implementations, the comparison component 212 can perform a single comparison when all iterations are completed (or the defined time has expired).

The implementation component 214 can facilitate implementation of the assignment determined to have the highest score at the end of the defined time. To facilitate the implementation, the implementation component 214 can output, as output data 226, various information that causes the objects to be assigned to the resource elements.

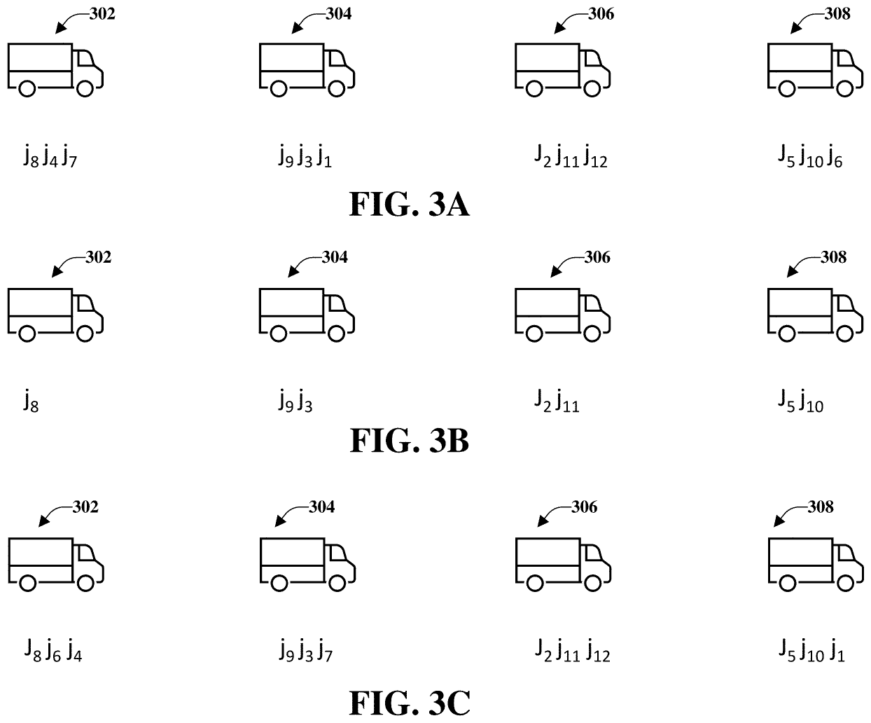

By way of example and not limitation, FIG. 3A illustrates an example, non-limiting schematic representation of objects being assigned to resources in accordance with one or more embodiments described herein. In the example of FIG. 3A, the allocation is related to field operations, the objects are jobs, and the resources elements are vehicles (alternatively, the resource elements can be technicians, where there is one technician per vehicle). The field operations can be, for example, installation, service, maintenance, and so on.

In this example, there are a certain number of jobs, and each job has its own priority. For example, as depicted in the table below, there can be twelve jobs (numbered 1 through 12) and each job has a priority level (e.g., demand decile). Although discussed with respect to 12 jobs for purposes of simplicity, the disclosed aspects are not limited to this implementation and any number of jobs can be utilized with the disclosed aspects. For example, hundreds, or even thousands, of jobs can be allocated to resource elements as discussed herein.

| Demand Decile | Job Number(s) |
|---|---|
| 0 | 12 |
| 10 | 1, 7 |
| 20 | |
| 30 | 4, 6 |
| 40 | 3 |
| 50 | 10 |
| 60 | |
| 70 | |
| 80 | 2, 5, 11 |
| 90 | 9 |
| 100 | 8 |

As indicated in the above table, the job with the highest priority or demand decile (100) is job 8 (j8). The job with the lowest priority/demand decile (0) is job 12 (j12). Further, some priorities/demand deciles are associated with more than one job. For example, demand decile 80 is associated with three jobs, namely, job 2 (j2), job 5 (j5), and job 11 (j11). Further, demand decile 30 is associated with two jobs, namely, job 4 (j4) and job 6 (j6). Additionally, demand decile 10 is associated with two jobs, namely, job 1 (j1) and job 7 (j7). Job 9 (j9) is assigned demand decile 90; job 10 (j10) is assigned demand decile 50; and job 3 (j3) is assigned demand decile 40.

Further, each job can have its own schedule based on, for example, availability to access the resource element. For example, in a customer's home, the customer might be expecting the technician between 2 and 4 in the afternoon. Therefore, that particular job should be scheduled within the hours of 2 and 4 (e.g., the expectation by the customer as to when the technician will arrive). Thus, inputs (or constraints) can include job priorities, job expectations, workload, load (e.g., technician load, vehicle load), distance between locations or travel time. Other constraints can include, but are not limited to, skill levels of the technicians and work schedules of the technicians (e.g., start time, end time, lunch time, breaks, and so on).

In some cases, the term technician and vehicle is used interchangeably since, in this example, there is one technician per vehicle. The objectives in this example are to optimize the job assignments while minimizing the distance being traveled and minimizing the idle time of the vehicle/technician. By achieving the objectives, more jobs can be completed while reducing costs.

As expressed in equation 1 above, for an area under consideration, there is a geographic area, which can be subdivided into smaller geographic areas (e.g., a small location, such as a neighborhood within a larger location, such as a city). For example, in a city, such as Dallas, there can be hundreds (if not thousands) of jobs, where each customer location represents a small area. A technician (and associated vehicle) begins the day at a first location, such as a garage where the vehicle is parked, and travels to a second location (e.g., location of the first job). If there is more than one job, the technician travels to a next job, and so on, until the end of the day when the technician returns to the first location (e.g., the garage). The sum of the distance from leaving the first location until returning to the first location is the distance traveled. The distance time is the complete amount of travel time.

As expressed in equation 2 above, there is also an idle time, which can be determined by taking the difference between the current job end time and the next job start time. The time can be expressed as the minutes of the day (e.g., 1440 minutes in a day) instead of taking the exact time. Thus, there can be two constraints (distance time and idle time).

As expressed in equation 3 above, the ω is the sum of the constraints (e.g., distance time and idle time), where a goal is to minimize this function. Thus, the disclosed embodiments are configured to find a solution where ω becomes as minimal as possible.

With continuing reference to FIG. 3A, there are four vehicles, illustrated as a first vehicle 302, a second vehicle 304, a third vehicle 306, and a fourth vehicle 308. For an initial job assignment, the jobs are assigned in descending order of priority. Thus, j₈ is assigned, such as to the first vehicle 302. Then j₉ is assigned, such as to the second vehicle 304. The next highest priority of jobs are j₂, j₅, and j₁. In this example, j₂ and j₁ are assigned to the third vehicle 306 and j₅ is assigned to the fourth vehicle 308. Further, the other jobs are assigned to the vehicles. For example, j₄ and j₇ can be assigned to the first vehicle 302; j₃ and j₁ can be assigned to the second vehicle 304; j₁₂ can be assigned to the third vehicle 306; and j₁₀ and j₆ can be assigned to the fourth vehicle 308.

This first assignment can be given a score, which indicates the quality level of the assignment. The scoring can be based on whether all the jobs, as assigned to a vehicle, are completed within a defined period of time (e.g., during the assigned shift of the technicians, such as 8 hours), while allowing the technician drive time to return the vehicle to the garage. In another example, the score can be based on whether the jobs, as assigned to a vehicle, are completed in less than the defined period of time, and so on. The respective scores assigned to each technician/vehicle can be averaged to determine a final score for the assignment of all the jobs, according to some implementations.

Once a first solution or initial job assignment is created, permutations of different combinations should be performed by routing at least a subset of the jobs among the technicians. This type of solutions needs a search, referred to as a search space. The search space includes all the jobs as well as all combinations of the jobs being assigned to technicians. In some cases, finding all the solutions could take a long amount of time, or a result might never be found, depending on the number of jobs, the number of technicians, and the number of combinations possible. Thus, the embodiments provided herein utilize a heuristic approach where, instead of searching in the entire space, the search is limited.

To limit the search, as previously discussed, anchor jobs are jobs that have a high priority and/or a high duration. The anchor jobs are the jobs that need to be assigned and completed today, for example. These jobs can be switched among the technicians (providing the technician has the skillset to complete the job), as long as the job is completed. In the examples provided herein, the anchor jobs are given a higher priority level.

Further, to limit the search, the disclosed embodiments utilize a process referred to as tail swap. To perform tail swap, some sequence of jobs of each technician/vehicle are swapped among technicians to determine if switching jobs between technicians results in a better solution, calculated as a solution score. Thus, instead of swapping all the jobs, only jobs that have a priority level below a defined priority are swapped and the priority jobs (e.g., the anchor jobs) are not moved between technicians.

FIG. 3B illustrates a subsequent iteration where a random strata is selected. In this example, the selected strata is 30. Therefore, jobs with a priority of 30 and below are removed from the assignment (e.g., the first assignment of FIG. 3A). The jobs with a priority higher than 30 remain assignment as determined for the first assignment. Thus, in FIG. 3B, j₈ is assigned to the first vehicle 302, j₉ and j₃ are assigned to the second vehicle 304, j₂ and j₁₁ are assigned to the third vehicle 306, and j₅ and j₁₀ are assigned to the fourth vehicle 308.

FIG. 3C illustrates a continuation of the subsequent iteration where jobs below the selected strata are assigned to vehicles. As illustrated the jobs that have a priority of 30 and below are randomly assigned to the vehicles. At least a subset of the jobs can be assigned to the same vehicles as in the previous iteration (e.g., FIG. 3A) or to different vehicles. The assignment of FIG. 3C is a second assignment, which can be given a second score, in a similar manner as the first score is determined. The first score and the second score can be compared and based on the comparison, the assignment having the best score can be utilized for the actual allocation. It is noted that although discussed with respect to two assignments, the disclosed embodiments can be utilized to determine dozens, hundreds, or more combinations of assignments within a defined period of time.

With continuing reference to FIG. 2, the systems and/or the components of the systems discussed herein can be employed to use hardware and/or software to solve problems that are highly technical in nature (e.g., determine allocations of objects to respective resource elements while satisfying one or more constraints associated with the objects and/or the resource elements, where there can be hundreds (or even thousands) of objects and/or resource elements, resulting in an unlimited number of possible combinations; performing the allocations by reducing and/or minimizing a search space; and so on), that are not abstract and that cannot be performed as a set of mental acts by a human. For example, a large number of permutations can be performed with respect to assigning and reassigning the objects while applying respective scores to each assignment within a limited amount of time (e.g., a defined time period). For example, a human, or even thousands of humans, cannot efficiently, accurately, and effectively manually generate the different allocations for objects at a multitude of resource elements while simultaneously adhering to various constraints and scoring each allocation within the defined amount of time. The various systems and/or components of the systems can be employed to solve new problems that arise through advancements in technology, computer networks, the Internet, and the like. The various systems can provide technical improvements to object allocation by improving processing efficiency among processing components in an allocation system by providing updated allocations and respective scores, automatically reconfigure the one or more allocations, automatically score the allocations, and so on, prior to expiration of the defined period of time. For example, the amount of data processed, the speed of processing of the data, and/or the electronic data types processed by the system 200 over a certain period of time can be respectively greater, faster, and different than the amount, speed, and data type that can be processed by a single human mind over the same period of time.

The at least one memory 216 can be operatively connected to the at least one processor 218. The at least one memory 216 and/or the at least one data store 220 can store executable instructions that, when executed by the at least one processor 218 can facilitate performance of operations. Further, the at least one processor 218 can be utilized to execute computer executable components stored in the at least one memory 216 and/or the at least one data store 220.

For example, the at least one memory 216 can store protocols associated with facilitating striated random restart during routing of resources using a heuristic approach as discussed herein. Further, the at least one memory 216 can facilitate action to control communication between the system 200, other apparatuses, other systems, network equipment, and/or user equipment associated with the categories under consideration, and so on, such that the system 200 can employ stored protocols and/or processes to facilitate reducing a search space as described herein.

It should be appreciated that data stores (e.g., memories) components described herein can be either volatile memory or nonvolatile memory or can include both volatile and nonvolatile memory. By way of example and not limitation, nonvolatile memory can include read only memory (ROM), programmable ROM (PROM), electrically Programmable ROM (EPROM), Electrically Erasable ROM (EEPROM), or flash memory. Volatile memory can include Random Access Memory (RAM), which acts as external cache memory. By way of example and not limitation, RAM is available in many forms such as Synchronous RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DRRAM). Memory of the disclosed aspects are intended to include, without being limited to, these and other suitable types of memory.

The at least one processor 218 can facilitate respective analysis of information related to one or more random permutations to implement, based on defined constraints, as discussed herein. The at least one processor 218 can be a processor dedicated to analyzing and/or generating information received, a processor that controls one or more components of the system 200, and/or a processor that both analyzes and generates information received and controls one or more components of the system 200.

Methods that can be implemented in accordance with the disclosed subject matter, will be better appreciated with reference to the various flow charts provided herein. While, for purposes of simplicity of explanation, the methods are shown and described as a series of blocks, it is to be understood and appreciated that the disclosed aspects are not limited by the number or order of blocks, as some blocks can occur in different orders and/or at substantially the same time with other blocks from what is depicted and described herein. Moreover, not all illustrated blocks can be required to implement the disclosed methods. It is to be appreciated that the functionality associated with the blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

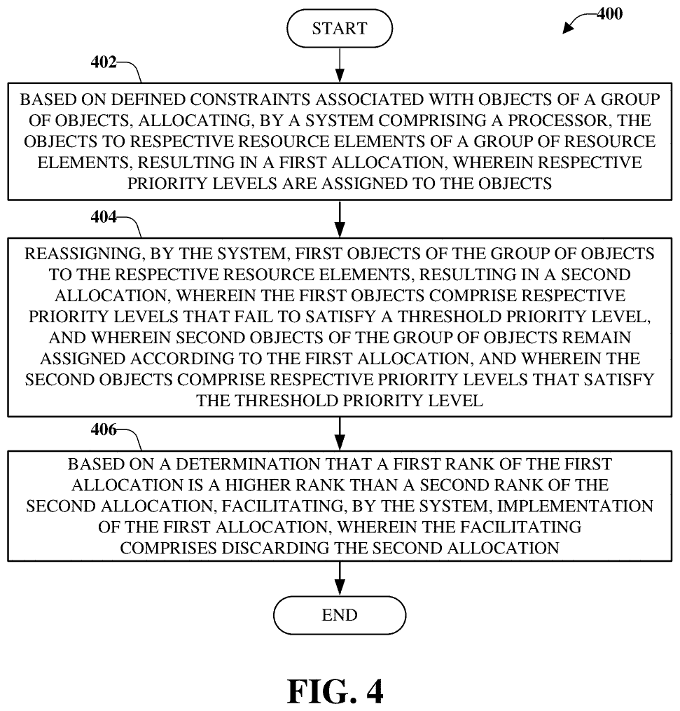

FIG. 4 illustrates an example, non-limiting, computer-implemented method 400 for facilitating striated random restart during routing of objects using a heuristic approach in accordance with one or more embodiments described herein. Repetitive description of like elements employed in other embodiments described herein is omitted for sake of brevity.

In some implementations, a system including a processor can perform the computer-implemented method 400 and/or other methods discussed herein. In other implementations, a device including a processor can perform the computer-implemented method 400 and/or other methods discussed herein. In other implementations, a machine-readable storage medium, can include executable instructions that, when executed by a processor, facilitate performance of operations, which can be the operations discussed with respect to the computer-implemented method 400 and/or other methods discussed herein. In further implementations, a non-transitory computer readable device and/or a non-transitory machine-readable medium including executable instructions that, in response to execution, cause a system including a processor to perform operations, which can be operations discussed with respect to the computer-implemented method 400 and/or other methods discussed herein.

The computer-implemented method 400 starts at 402 with allocating, by a system including a processor, objects of a group of objects to respective resource elements of a group of resource elements, resulting in a first allocation (e.g., via the allocation component 206). The allocation can be based on defined constraints (e.g., input data 224) associated with the objects. According to some implementations, the defined constraints can include, for respective resource elements, a distance time and an idle time. The allocation can be further based on respective priority levels assigned to the objects. The allocation at 402 can be an initial allocation where anchor objects (or highest priority objects) are assigned prior to the assignment of non-anchor objects.

At 404, the system can reassign first objects of the group of objects to the respective resource elements, resulting in a second allocation (e.g., via the allocation component 206). The first objects can include respective priority levels that fail to satisfy a threshold priority level. Second objects of the group of objects remain assigned according to the first allocation. The second objects can include respective priority levels that satisfy the threshold priority level.

According to some implementations, reassigning the first objects (and/or subsequent objects) can include permuting, by the system, the first objects randomly between the respective resource elements. In an example, the reassigning can include using a striation function to divide the group of objects into a finite number of groupings. Respective objects of the group of objects belong to a single grouping of the finite number of groupings (e.g., no object belongs to more than one grouping).

Further, based on a determination that a first rank (e.g., a first score) of the first allocation is a higher rank than a second rank (e.g., a second score) of the second allocation, at 406, the system can facilitate implementation of the first allocation, which can include discarding the second allocation (e.g., via the implementation component 406). Discarding the second allocation can include not outputting information related to the second allocation as output data. In some implementations, discarding the second allocation can include retaining information related to the allocation of the objects to the resource elements in memory and indicating (e.g., in metadata) that the second allocation is not to be used, for example. The metadata can include the second score and/or other information related to the second allocation.

In some cases, instead of the determination being that the first rank is a higher rank than the second rank, the determination can be that the second rank of the second allocation is more than the first rank of the first allocation. In this alternative implementation, the system can facilitate implementation of the second allocation. Further, the first allocation can be discarded (e.g., ignored, not used, and so on).

According to some implementations, reassigning the first objects can include reducing a search space of the group of objects. Reducing the search space can include performing the allocating, the reassigning, and the facilitating implementation of the first allocation (or alternatively the second allocation) are performed within a defined time period.

According to some implementations and during a defined time period, reducing the search space can include reassigning, by the system, third objects of the group of objects to the respective resource elements, resulting in a third allocation. The third objects can include respective priority levels that fail to satisfy the threshold priority level. Fourth objects of the group of objects can remain assigned according to the first allocation. The fourth objects can include respective priority levels that satisfy the threshold priority level. Further to these implementations, based on a second determination that a third rank of the third allocation is more than the first rank of the first allocation, the computer-implemented method 400 can include facilitating, by the system, implementation of the third allocation and discarding (e.g., ignoring, not using, and so on) the first allocation.

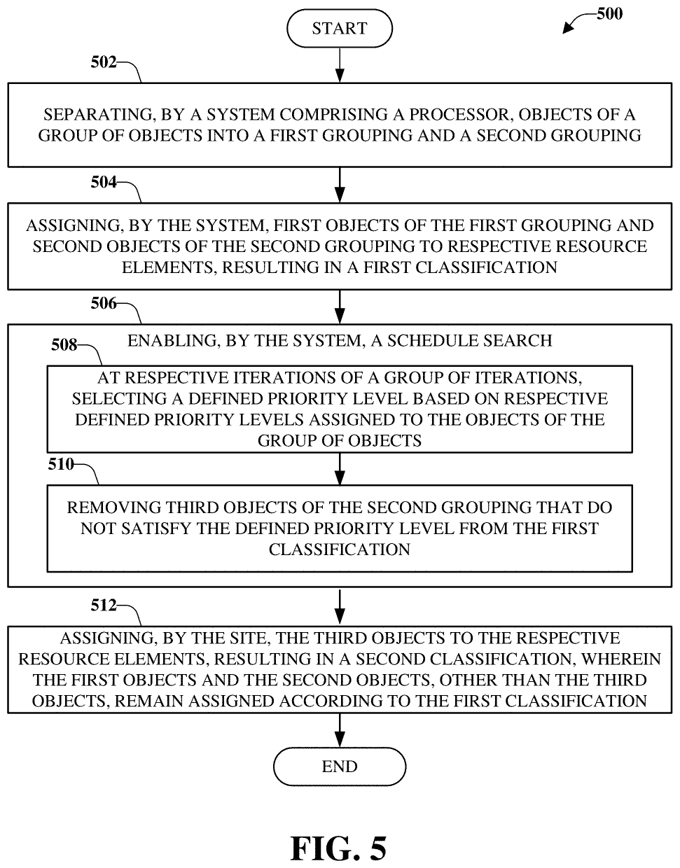

FIG. 5 illustrates a flow diagram of an example, non-limiting, computer-implemented method 500 that facilitates reducing a search space during allocation of resources in accordance with one or more embodiments described herein. Repetitive description of like elements employed in other embodiments described herein is omitted for sake of brevity.

The computer-implemented method 500 starts, at 502, when objects of a group of objects are separated into a first grouping and a second grouping (e.g., via the grouping component 204). The first grouping can include anchor objects and the second grouping can include non-anchor objects. According to another implementation, the first grouping can include objects determined to have a priority level above a first defined priority level and the second grouping can include objects determined to have a priority level at or below the first defined priority level. According to some implementations, the first objects are classified as anchor objects that satisfy one of the defined priority level or a defined duration level.

At 504, first objects of the first grouping and second objects of the second grouping are assigned to respective resource elements, resulting in a first classification (e.g., via the allocation component 206). For example, the first objects of the first grouping (e.g., the anchor objects) are assigned and then the second objects of the second grouping (e.g., the non-anchor objects) are assigned, as discussed with respect to FIG. 3A. According to some implementations, after assigning the first objects, the computer-implemented method 500 can randomly permutate the second objects among the respective resource elements, as discussed with respect to FIG. 3B and FIG. 3C.

A schedule search is enabled, at 506 (e.g., via the search component 210). The schedule search can be configured to reduce a search space associated with allocating objects as discussed herein. Enabling the search space can include, at respective iterations of a group of iterations, selecting, at 508, a defined priority level based on respective defined priority levels assigned to the objects of the group of objects (e.g., via the priority component 202). The respective defined priority levels can be received as input data (e.g., the input data 224), for example. Further, at 510, third objects of the second grouping that do not satisfy the defined priority level can be removed from the first classification, as discussed with respect to FIG. 3B. At 512, the third objects can be assigned to the respective resource elements, resulting in a second classification while the first objects and the second objects, other than the third objects, remain assigned according to the first classification, as discussed with respect to FIG. 3C (e.g., via the allocation component 206).

Separating the group of objects can include using a striation function that separates the objects into a finite number of groupings. In an example, the striation function is an unsupervised clustering process. In another example, the striation function is a quintile operation. According to another example, the striation function is a quartile operation. In yet another example, the striation function is a decile operation.

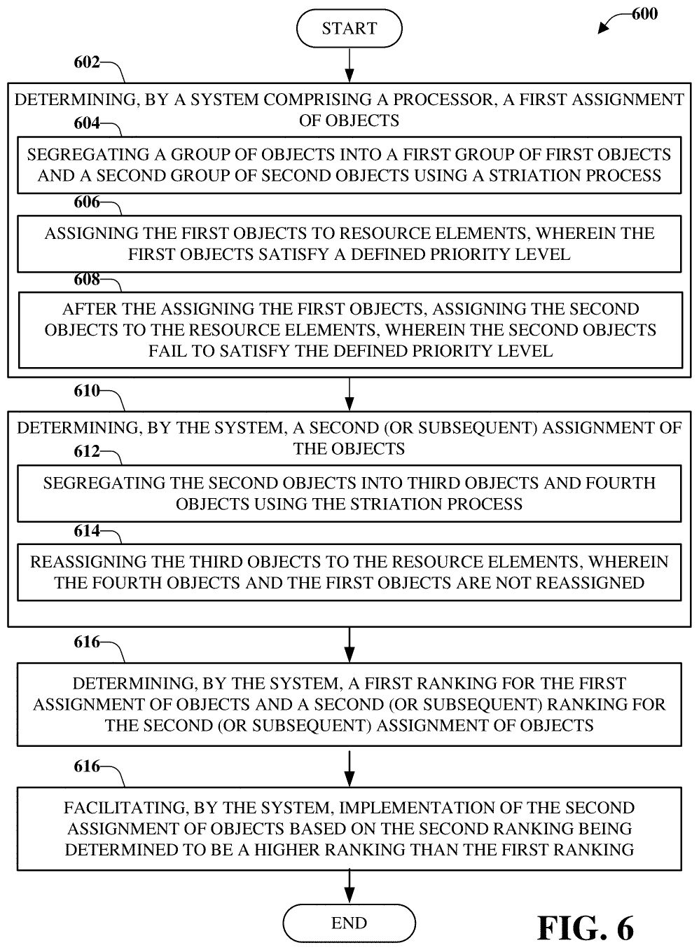

FIG. 6 illustrates an example, non-limiting, computer-implemented method 600 that facilitates a striated random restart during routing of resources using a heuristic approach in accordance with one or more embodiments described herein. Repetitive description of like elements employed in other embodiments described herein is omitted for sake of brevity.

At 602 a first assignment of objects is determined (e.g., via the allocation component 206). This determination can include, at 604, segregating a group of objects into a first group of first objects and a second group of second objects using a striation process. Further, at 606, the first objects can be assigned to resource elements, wherein the first objects satisfy a defined priority level. Additionally, at 608, the determination of the first assignment of objects can include, after the assigning the first objects, assigning the second objects to the resource elements, wherein the second objects fail to satisfy the defined priority level.

A second assignment of objects can be determined, at 610 (e.g., via the allocation component 206). Determining the second assignment of objects can include, at 612, segregating the second objects into third objects and fourth objects using the striation process. Further, the third objects can be reassigned to the resource elements, at 614, wherein the fourth objects and the first objects are not reassigned.

At 616, a first ranking for the first assignment of objects and a second ranking for the second assignment of objects can be determined (e.g., via the scoring component 208). Further, at 618, the computer-implemented method 600 can include facilitating implementation of the second assignment of objects based on the second ranking being determined to be a higher ranking than the first ranking (e.g., via the implementation component 214). The method 600 can return, via a feedback loop, to 610, for a subsequent assignment of objects and a subsequent ranking, as discussed herein.

According to some implementations, determining the first assignment of objects at 602 and determining the second assignment of objects at 610 can include reducing a search space associated with the group of objects. Further, in some implementations, determining the first assignment of objects, determining the second assignment of objects, determining the ranking, and facilitating implementation of the second assignment of objects can be executed by the processor within a defined time period. For example, the defined time period can be measured in minutes (e.g., three minutes, two minutes, one minute, and so on). In another example, the defined time period can be measured in seconds (e.g., fifty seconds, thirty five seconds, twenty seconds, seven seconds, and so on). In a further example, the defined period of time can be measured in milliseconds (e.g., twenty five milliseconds, eleven milliseconds, three milliseconds, and so on).

To demonstrate the capability of the proposed embodiments in CVRPs, experiments related to the performance of the disclosed embodiments is compared using a pair of metric CVRP cases. Metric CVRP cases are where the distances between points satisfy triangle inequality property (e.g., the distances between two points a and b is the same as the distance between b and a and adding another point to a tour strictly increases the tour length). The problems are taken from TSPLIB, a library of TSP and related problems that have been used as benchmark and test cases for a number of published results for heuristic solvers for TSP problems. The problems provide a lower triangular distance matrix between job locations, a maximum capacity for trucks, the number of trucks, and the demand loads for each job. The objective of these problems is to find an optimal job assignment that satisfies truck capacity (e.g., sum of assigned job loads are less than or equal to truck capacity) and minimizes the sum of the tour lengths. The two cases define cases for 13 and 31 jobs (eil13 and eil31, respectively). First compare performance of the first fit decreasing method (FFD), first fit decreasing with tail swaps (FFD with tail swap), the striated random restart with no iterations (SRR iter 0), and the striated random restart with iterations (SRR). In both 13 and 31 problem cases, SRR iteration 0 performs similarly to FFD with no tail swaps, and SRR outperforms FFD with tail swaps.

FIG. 7 illustrates a graph 700 of a first group of simulated cases and related performance comparisons in accordance with one or more embodiments described herein. The first group of simulated cases represent 13 cases (e.g., eil13). Results for first fit decreasing (FFD) is depicted in the first column 702. FFD with tail swaps (e.g., first fit decreasing with tail swaps in feasible solution (same number of iterations used as in SRR iterations)) is depicted in the second column 704. Results for SRR iteration 0 (Striated random restart with no random restarts) is depicted in the third column 706. Further, results for striated random restart with random restarts (SRR) is depicted in the fourth column 708. For the first group of simulated cases (e.g., eil13), FDD is similar to striation 0.

FIG. 8 illustrates a graph 800 of a second group of simulated cases and related performance comparisons in accordance with one or more embodiments described herein. The second group of simulated cases represent 31 cases (eil31). Results for FFD is depicted in the first column 802. Results for FFD with tail swaps is depicted in the second column 804. Results for SRR iteration 0 is depicted in the third column 806. Further, results for SRR is depicted in the fourth column 808.

In both eil13 and eil31 simulated sets (as illustrated in FIGS. 7 and 8), the four methods performed similar to the original eil13 and eil31 cases. FFD and SRR iteration 0 performed similarly, while SRR outperformed all methods.

Table 1 below provides a performance comparison on the TSPLIB cases of FIGS. 7 and 8.

TABLE 1

| Case | FDD | FDD with tail swap | SRR iteration 0 | SRR |
|---|---|---|---|---|
| eil13 | 412 | 366 | 369 | 331 |
| eil31 | 999 | 926 | 1117 | 731 |

Simulated cases based on these two examples from TSPLIB were generated to further demonstrate performance In these simulated cases, distance matrices were generated using a discrete uniform random sample over the range of distances given in the TSPLIB case. A discrete uniform random sample of values was used to generate job demands over the range of values given in the TSPLIB case. Thirty simulated cases were generated and evaluated using the four solving methods. FIGS. 7 and 8 show the mean and standard errors of each methods solutions.

Described herein are systems, methods, articles of manufacture, and other embodiments or implementations that can facilitate striated random restart during routing of resources using a heuristic approach. For example, an embodiment relates to a striated random restart, such as a heuristic method for solving capacitated vehicle routing problems. According to an example, non-limiting, implementation, deciding how to optimally dispatch a workforce to field work is a problem for service firms, and one that has been the focus for a number of research efforts from many fields of study. For example, as it relates to computing technologies, a wireline technician field workforce installs services for customers and repairs problems in the field network plant. Each day, new install and repair jobs need to be scheduled to technicians who can complete the jobs.

Completing jobs as efficiently as possible simultaneously improves customer experience, lowers operations costs for the service provider (or another controlling entity), and maintains outside wireline network plant health. A problem the disclosed embodiments addresses is how to optimally schedule these jobs to technicians (or another resource element) in each area every day: technicians work in shifts, and the service provider's objective is to fill technician shift times daily with jobs that need completion. The disclosed embodiments use the distribution of job durations and priorities to enable search space diversity and create reusable partial plans whose aim is to minimize the risk of omitting global optima from the feasible search space. The disclosed embodiments include a new heuristic optimization method (as well as related systems and other embodiments) that uses insights and intuitions from job assignment cases in a service provider's field services (e.g., management of resource elements).

Scheduling jobs to technicians is a process of matching job skill requirements with technician trained skills and ensuring the job location and duration fit within the technicians locations and shift times while being sensitive to technician break times and meals. An objective of the disclosed embodiments is to generate the most efficient schedule possible each day (most jobs completed, and least miles driven) and in each geographical area where a service provider offers services and has network assets in the field. Further, the method must complete in a prescribed amount of time. In the context of heuristic optimization, the current best solution is taken at the end of execution time. This problem is more generally referred to as the Capacitate Vehicle Routing Problem (CVRP).

This class of problems are not only a common practical one, but it is a class of problems important to the operations research and computer science communities known more broadly as the Travelling Salesman Problem (TSP). The disclosed embodiments use an insight derived from analyzing scheduling data in field services, for example, to search candidate job schedules in a way that improves schedule quality over existing methods. The disclosed embodiments are applicable to related problems involving scheduling visits to locations. While a general solution to CVRPs and TSPs are not possible assuming P≠NP (e.g., assuming polynomial time P does not equal non-deterministic polynomial time NP), the disclosed embodiments provide improved performance over existing methods for CVRPs that service providers' field services encounter.

The various aspects (e.g., in connection with allocating a multitude of objects to a multitude of resources or resource elements while satisfying one or more constraints, resulting in a multitude of combinations; assigning respective scores to combinations of the multitude of combinations, and so forth) can employ various artificial intelligence-based schemes for carrying out various aspects thereof. For example, a process for determining if a particular action is a request for an action to be performed or a general action (e.g., an action that the user desires to perform manually) can be enabled through an automatic classifier system and process.

A classifier is a function that maps an input attribute vector, x=(x1, x2, x3, x4, xn), to a confidence that the input belongs to a class. In other words, f(x)=confidence (class). Such classification can employ a probabilistic and/or statistical-based analysis (e.g., factoring into the analysis utilities and costs) to provide a prognosis and/or infer one or more actions that should be employed to determine what should be automatically performed.

A Support Vector Machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing user behavior, by receiving extrinsic information, and so on). For example, SVMs can be configured through a learning or training phase within a classifier constructor and feature selection module. Thus, a classifier(s) can be used to automatically learn and perform a number of functions, including but not limited to determining, according to a predetermined criterion, when to implement an assignment, which assignment to implement, what objects to assign to which resources, and so forth. The criteria can include, but is not limited to, similar allocations, historical information, and so forth.

Additionally, or alternatively, an implementation scheme (e.g., a rule, a policy, and so on) can be applied to control and/or regulate requests and resulting actions, inclusion of a group of users to carry out actions associated with the requests, privileges, and so forth. In some implementations, based upon a predefined criterion, the rules-based implementation can automatically and/or dynamically interpret requests. In response thereto, the rule-based implementation can automatically interpret and carry out functions associated with the request by employing a predefined and/or programmed rule(s) based upon any desired criteria.

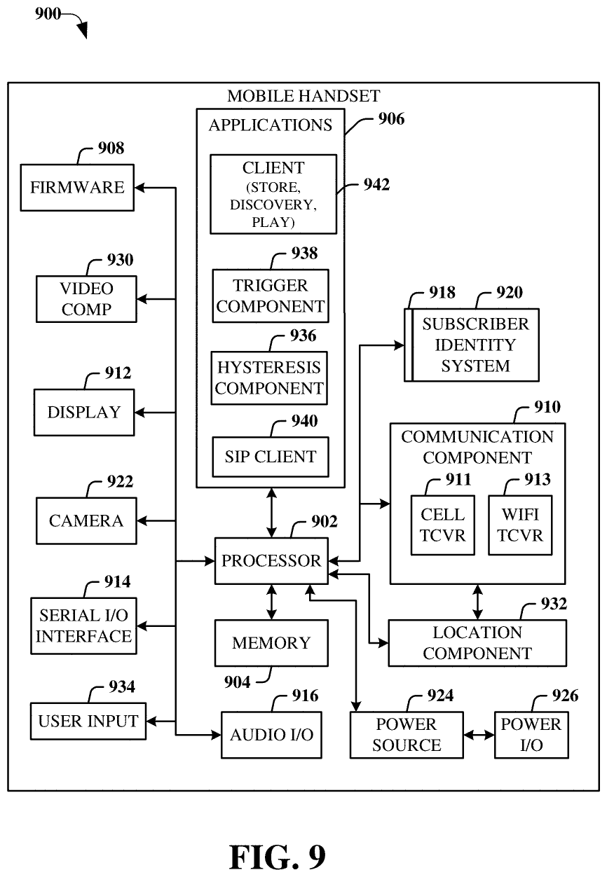

Referring now to FIG. 9, illustrated is an example, non-limiting, block diagram of a handset 900 operable to engage in a system architecture that facilitates wireless communications according to one or more embodiments described herein. Although a mobile handset is illustrated herein, it will be understood that other devices can be a mobile device, and that the mobile handset is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information, and which can be accessed by the computer.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset includes a processor 902 for controlling and processing all onboard operations and functions. A memory 904 interfaces to the processor 902 for storage of data and one or more applications 906 (e.g., a video player software, user feedback component software, etc.). Other applications can include voice recognition of predetermined voice commands that facilitate initiation of the user feedback signals. The applications 906 can be stored in the memory 904 and/or in a firmware 908, and executed by the processor 902 from either or both the memory 904 or/and the firmware 908. The firmware 908 can also store startup code for execution in initializing the handset 900. A communications component 910 interfaces to the processor 902 to facilitate wired/wireless communication with external systems, e.g., cellular networks, VoIP networks, and so on. Here, the communications component 910 can also include a suitable cellular transceiver 911 (e.g., a GSM transceiver) and/or an unlicensed transceiver 913 (e.g., Wi-Fi, WiMax) for corresponding signal communications. The handset 900 can be a device such as a cellular telephone, a PDA with mobile communications capabilities, and messaging-centric devices. The communications component 910 also facilitates communications reception from terrestrial radio networks (e.g., broadcast), digital satellite radio networks, and Internet-based radio services networks.

The handset 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor 902 to facilitate wired and/or wireless serial communications (e.g., USB, and/or IEEE 1394) through a hardwire connection, and other serial input devices (e.g., a keyboard, keypad, and mouse). This can support updating and troubleshooting the handset 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The handset 900 can include a slot interface 918 for accommodating a SIC (Subscriber Identity Component) in the form factor of a card Subscriber Identity Module (SIM) or universal SIM 920, and interfacing the SIM card 920 with the processor 902. However, it is to be appreciated that the SIM card 920 can be manufactured into the handset 900, and updated by downloading data and software.

The handset 900 can process IP data traffic through the communications component 910 to accommodate IP traffic from an IP network such as, for example, the Internet, a corporate intranet, a home network, a person area network, etc., through an ISP or broadband cable provider. Thus, VoIP traffic can be utilized by the handset 900 and IP-based multimedia content can be received in either an encoded or decoded format.

A video processing component 922 (e.g., a camera) can be provided for decoding encoded multimedia content. The video processing component 922 can aid in facilitating the generation, editing, and sharing of video quotes. The handset 900 also includes a power source 924 in the form of batteries and/or an AC power subsystem, which power source 924 can interface to an external power system or charging equipment (not shown) by a power I/O component 926.

The handset 900 can also include a video component 930 for processing video content received and, for recording and transmitting video content. For example, the video component 930 can facilitate the generation, editing and sharing of video quotes. A location tracking component 932 facilitates geographically locating the handset 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touchscreen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 936 when the Wi-Fi transceiver 913 detects the beacon of the access point. A SIP client 940 enables the handset 900 to support SIP protocols and register the subscriber with the SIP registrar server. The applications 906 can also include a client 942 that provides at least the capability of discovery, play and store of multimedia content, for example, music.

The handset 900, as indicated above related to the communications component 910, includes an indoor network radio transceiver 913 (e.g., Wi-Fi transceiver). This function supports the indoor radio link, such as IEEE 802.11, for a dual-mode GSM handset. The handset 900 can accommodate at least satellite radio services through a handset that can combine wireless voice and digital radio chipsets into a single handheld device.

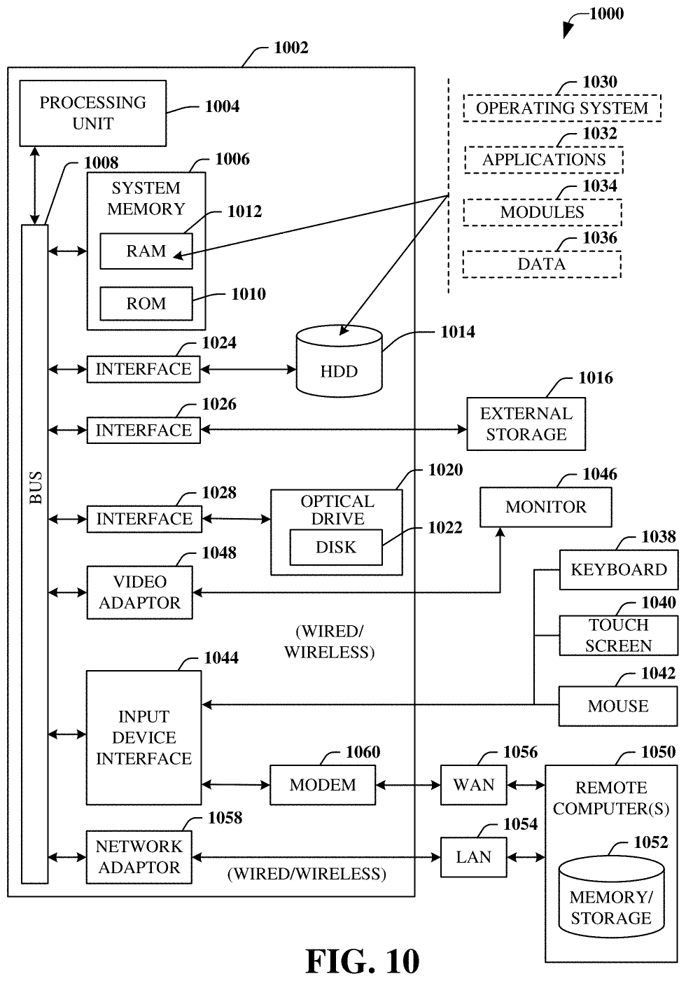

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A Basic Input/Output System (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally include emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can include one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For example, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

An aspect of 5G, which differentiates from previous 4G systems, is the use of NR. NR architecture can be designed to support multiple deployment cases for independent configuration of resources used for RACH procedures. Since the NR can provide additional services than those provided by LTE, efficiencies can be generated by leveraging the pros and cons of LTE and NR to facilitate the interplay between LTE and NR, as discussed herein.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” and the like are intended to refer to, or can include, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device,” “user equipment” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

The various aspects described herein can relate to New Radio (NR), which can be deployed as a standalone radio access technology or as a non-standalone radio access technology assisted by another radio access technology, such as Long Term Evolution (LTE), for example. It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, 6G, a UMTS implementation, and/or an LTE implementation as the techniques can also be applied in 3G, 4G, or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

As used herein, “5G” can also be referred to as NR access. Accordingly, systems, methods, and/or machine-readable storage media for facilitating link adaptation of downlink control channel for 5G systems are desired. As used herein, one or more aspects of a 5G network can include, but is not limited to, data rates of several tens of megabits per second (Mbps) supported for tens of thousands of users; at least one gigabit per second (Gbps) to be offered simultaneously to tens of users (e.g., tens of workers on the same office floor); several hundreds of thousands of simultaneous connections supported for massive sensor deployments; spectral efficiency significantly enhanced compared to 4G; improvement in coverage relative to 4G; signaling efficiency enhanced compared to 4G; and/or latency significantly reduced compared to LTE.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification procedures and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
based on defined constraints associated with objects of a group of objects, allocating, by a system comprising a processor, the objects to respective resource elements of a group of resource elements, resulting in a first allocation, wherein respective priority levels are assigned to the objects;
reassigning, by the system, first objects of the group of objects to the respective resource elements, resulting in a second allocation, wherein the first objects comprise respective priority levels that fail to satisfy a threshold priority level, and wherein second objects of the group of objects remain assigned according to the first allocation, and wherein the second objects comprise respective priority levels that satisfy the threshold priority level; and
based on a determination that a first rank of the first allocation is a higher rank than a second rank of the second allocation, facilitating, by the system, implementation of the first allocation, wherein the facilitating comprises discarding the second allocation.

2. The method of claim 1, wherein the reassigning comprises reducing a search space of the group of objects, and wherein the allocating, the reassigning, and the facilitating are performed within a defined time period.

3. The method of claim 1, wherein the defined constraints comprise, for respective resource elements, a distance time and an idle time.

4. The method of claim 1, wherein the determination is a first determination, and wherein the method further comprises:
based on a second determination that the second rank of the second allocation is more than the first rank of the first allocation, facilitating, by the system, implementation of the second allocation, wherein the facilitating comprises discarding the first allocation.

5. The method of claim 1, wherein the determination is a first determination, and wherein the method further comprises:
reassigning, by the system, third objects of the group of objects to the respective resource elements, resulting in a third allocation, wherein the third objects comprise respective priority levels that fail to satisfy the threshold priority level, wherein fourth objects of the group of objects remain assigned according to the first allocation, and wherein the fourth objects comprise respective priority levels that satisfy the threshold priority level; and
based on a second determination that a third rank of the third allocation is more than the first rank of the first allocation, facilitating, by the system, implementation of the third allocation, wherein the facilitating comprises discarding the first allocation.

6. The method of claim 1, wherein the reassigning comprises permuting, by the system, the first objects randomly between the respective resource elements.

7. The method of claim 1, wherein the reassigning comprises using a striation function to divide the group of objects into a finite number of groupings.

8. The method of claim 7, wherein respective objects of the group of objects belong to a single grouping of the finite number of groupings.

9. A system comprising:
a processor; and
a memory that stores executable instructions that, when executed by the processor, facilitate performance of operations, comprising:
separating objects of a group of objects into a first grouping and a second grouping;
assigning first objects of the first grouping and second objects of the second grouping to respective resource elements, resulting in a first classification;
enabling a schedule search, wherein the enabling comprises:
at respective iterations of a group of iterations, selecting a defined priority level based on respective defined priority levels assigned to the objects of the group of objects;
removing third objects of the second grouping that do not satisfy the defined priority level from the first classification; and
assigning the third objects to the respective resource elements, resulting in a second classification, wherein the first objects and the second objects, other than the third objects, remain assigned according to the first classification.

10. The system of claim 9, wherein the first objects are classified as anchor objects that satisfy one of the defined priority level or a defined duration level.

11. The system of claim 9, wherein after the assigning the first objects, the operations comprise randomly permutating the second objects among the respective resource elements.

12. The system of claim 9, wherein the separating comprises using a striation function that separates the objects into a finite number of groupings.

13. The system of claim 12, wherein the striation function is an unsupervised clustering process.

14. The system of claim 12, wherein the striation function is a quintile operation.

15. The system of claim 12, wherein the striation function is a quartile operation.

16. The system of claim 12, wherein the striation function is a decile operation.

17. The system of claim 9, wherein the schedule search reduces a search space of the group of objects.

18. A non-transitory machine-readable medium, comprising executable instructions that, when executed by a processor, facilitate performance of operations, comprising:
determining a first assignment of objects comprising:
segregating a group of objects into a first group of first objects and a second group of second objects using a striation process;
assigning the first objects to resource elements, wherein the first objects satisfy a defined priority level, and
after the assigning the first objects, assigning the second objects to the resource elements, wherein the second objects fail to satisfy the defined priority level;
determining a second assignment of objects comprising:
segregating the second objects into third objects and fourth objects using the striation process;
reassigning the third objects to the resource elements, wherein the fourth objects and the first objects are not reassigned;
determining a first ranking for the first assignment of objects and a second ranking for the second assignment of objects; and
facilitating implementation of the second assignment of objects based on the second ranking being determined to be a higher ranking than the first ranking.

19. The non-transitory machine-readable medium of claim 18, wherein the determining the first assignment of objects and the determining the second assignment of objects comprises reducing a search space associated with the group of objects.

20. The non-transitory machine-readable medium of claim 18, wherein the determining the first assignment of objects, the determining the second assignment of objects, the determining the ranking, and the facilitating are executed by the processor within a defined time period.
